(19) United States
(12) Patent Application Publication
(10) Pub. No.: US 2011/0129262 A1
(43) Pub. Date: Jun. 2, 2011

(54) Development device, image forming apparatus, and method for manufacturing development device

(75) Inventor: Atsushi Nakamoto, Kanagawa-ken (JP)

(73) Assignee: Ricoh Company, Ltd., Tokyo (JP)

(21) Appl. No.: 12/926,556

(22) Filed: Nov. 24, 2010

(30) Foreign Application Priority Data
Nov. 27, 2009 (JP) 2009-270278

(51) Int. Cl. G03G 15/08; B23P 17/00

(52) U.S. Cl. 399/286; 29/895.2

(57) ABSTRACT

A development device develops a latent image on an image carrier with developer. The development device includes a first rotatable development roller, a developer regulator, and a second rotatable development roller. The first rotatable development roller to bear the developer is provided facing the image carrier includes an axial rotary shaft and multiple grooves formed in a surface of the first development roller. The developer regulator is provided at a position facing the first development roller and restricts the amount of developer borne on the first development roller. The second rotatable development roller to bear the developer is provided facing the image carrier and not facing the developer regulator, and the second development roller having a convex and concave irregular surface.

### CROSS-REFERENCE TO RELATED APPLICATIONS

This patent specification is based on and claims priority from Japanese Patent Application No. 2009-270278, filed on Nov. 27, 2009 in the Japan Patent Office, which is hereby incorporated by reference herein in its entirety.

### BACKGROUND OF THE INVENTION

1. Field of the Invention

The present invention generally relates to a development device including multiple development rollers, a process cartridge, and an image forming apparatus such as a copier, a printer, a facsimile machine, or a multifunction machine capable of at least two of these functions and which includes the development device.

2. Discussion of the Background Art

In general, electrophotographic image forming apparatuses, such as copiers, printers, facsimile machines, or multifunction devices including at least two of those functions, etc., include a latent image carrier on which an electrostatic latent image is formed and a development device to develop the latent image with developer. In electrophotographic images forming apparatuses, two-component developer consisting essentially of toner and carrier particles is widely used.

Such development devices using the two-component developer include single or multiple development rollers (developer bearer) disposed facing a photoconductor drum (also referred to as an image carrier). Each development roller includes a sleeve (in other words, a cylinder) that rotates in a predetermined direction and a magnet provided inside the sleeve. The development device further includes at least one agitator, such as a transport screw or a transport paddle.

Then, the development device is replenished with toner as appropriate as the toner is consumed. The replenished toner is agitated and mixed by the agitator. The developer thus agitated and mixed is partly transported to the development roller. The developer carried on the development roller is regulated as needed, and then the toner in the two-component developer adheres to the photoconductor drum.

In order to improve conveyance ability (retaining force) of the development roller, in a first example proposed in JP-2000-321864-A, and JP-2003-270923-A, multiple V-shaped grooves extending in a rotary axial direction are formed on a circumferential of the sleeve of the development roller at predetermined intervals.

However, in this example, the toner adheres in a V-shaped groove in the development roller (development bearer) over time, which causes scattering on the background of the output image and reduction of the toner concentration of the developer.

In a second example proposed in JP-2002-62725-A and JP-2004-163906-A, in order to prevent toner adhesion on a surface of a development roller, the differences in the level of the surface due to the grooves (recessed amount) and interval between projection peaks formed on a sleeve surface (development roller surface) by sandblasting are limited.

Further, in a third example, JP-2004-163906-A, JP-2004-85630-A, JP-2002-268382-A, in order to increase the speed of the image forming apparatus, a development device using two-component developer includes multiple development rollers.

In the first example of the development device including the development roller grooved at predetermined intervals along the rotary shaft, because the development roller thus grooved is less likely to retain the developer uniformly on an entire surface thereof, toner adhesion is more likely to occur by receiving pressure at a position facing a doctor blade over time, thus destabilizing image quality compared with the development roller in the second example of the development device that includes a development roller whose surface is formed of convexities and concave irregularities.

By contrast, in the second example of the development device, because the convex and concave irregularities formed on the development roller has poorer resistance to abrasion over time than the grooved development roller, and accordingly the degree of deterioration in the transport ability (retaining force) of the developer is higher, image degradation is more likely to occur.

In view of foregoing, there is a need for a development device to maintain reliable transport ability of the developer on the development roller and to provide consistent image quality over time.

### SUMMARY OF THE INVENTION

In view of the foregoing, one illustrative embodiment of the present invention provides a development device to develop a latent image on an image carrier with developer. The development device includes a first rotatable development roller, a developer regulator, and a second rotatable development roller. The first rotatable development roller to bear the developer is provided facing the image carrier and includes an axial rotary shaft and multiple grooves formed in a surface of the first development roller. The developer regulator is provided at a position facing the first development roller and restricts the amount of developer borne on the first development roller. The second rotatable development roller to bear the developer is provided facing the image carrier and not facing the developer regulator. The second rotatable development roller includes an axial rotary shaft and has a convex and concave irregular surface.

Another illustrative embodiment of the present invention provides an image forming apparatus that includes an image carrier to bear a latent image and a development device described above.

Another illustrative embodiment of the present invention provides a method for manufacturing a development device that includes forming a first rotatable development roller to bear the developer and provided facing an image carrier, forming multiple grooves formed in a surface of the first development roller arranged at intervals in a circumferential direction of the first development roller, providing a developer regulator to restrict the amount of developer borne on the first development roller at a position facing the first development roller, forming a second rotatable development roller to bear the developer and provided facing the image carrier and not facing the developer regulator, and abrading a surface of the second development roller to make convex and concave irregularities.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram illustrating a configuration of an image forming apparatus according to an illustrative embodiment of the present invention;

FIG. 2 is a schematic diagram illustrating a configuration of an image forming unit included in the image forming apparatus shown in FIG. 1;

FIG. 3 schematically illustrates horizontal cross sections of the development device shown in FIG. 2, viewed in the longitudinal direction, and (A) and (B) respectively illustrate an upper portion and a lower portion of the development device in a longitudinal direction;

FIG. 4 illustrates a vertical cross section of the development device shown in FIG. 3, viewed in the longitudinal direction;

FIG. 5 is an end-on axial view that illustrates distribution of lines of magnetic force exerted by multiple magnetic poles formed around development rollers;

FIGS. 6A through 6C are schematic diagrams illustrating the development rollers that face a doctor blade;

FIGS. 7A through 7C are schematic expanded diagrams in cross-section illustrating grooves in surfaces of the development rollers that face the doctor blade;

FIG. 8 is schematic diagrams illustrating the development roller that does not face the doctor blade;

FIG. 9 is a configuration diagram illustrating a main part of a development device according to another embodiment;

FIG. 10 is a configuration diagram illustrating a main part of a development device according to yet another embodiment; and

FIG. 11 is a configuration diagram illustrating a main part of a development device according to yet another and further embodiment.

### DETAILED DESCRIPTION OF PREFERRED EMBODIMENTS

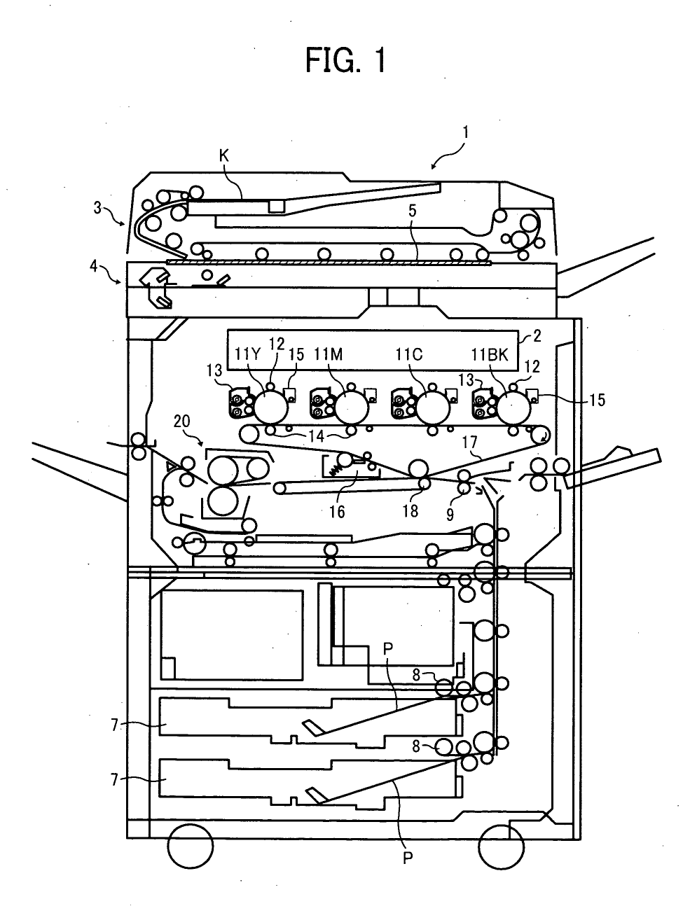

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result. Referring now to the drawings, wherein like reference numerals designate identical or corresponding parts throughout the several views thereof, and particularly to FIG. 1, a multicolor image forming apparatus according to an illustrative embodiment of the present invention is described.

FIG. 1 is a schematic diagram illustrating a configuration of a tandem multicolor image forming apparatus 1.

It is to be noted that the subscripts Y, M, C, and BK attached to the end of each reference numeral indicate only that components indicated thereby are used for forming yellow, magenta, cyan, and black images, respectively, and hereinafter may be omitted when color discrimination is not necessary.

In FIG. 1, reference number 2 represents a writing unit to emit laser beams according to image data, 3 represents a document feeder to send an original document D to a document reading unit 4 that reads image data of the original document D, 7 represents a sheet cassette containing sheets P of recording media, 8 represents feed rollers, 9 represents a pair of registration rollers to adjust the timing to transport the sheet P, 11 represents photoconductor drums serving as image carriers on which yellow, magenta, cyan, and black toner images are formed, respectively, 12 represents charging members to charge surfaces of the respective photoconductor drums 11, 13 represents development devices to develop electrostatic latent images formed on the respective photoconductor drums 11, 14 represents primary-transfer bias rollers to transfer toner images formed on the respective photoconductor drums 11 onto an intermediate transfer belt 17, and 15 represents cleaning units to clean the surfaces of the respective photoconductor drums 11.

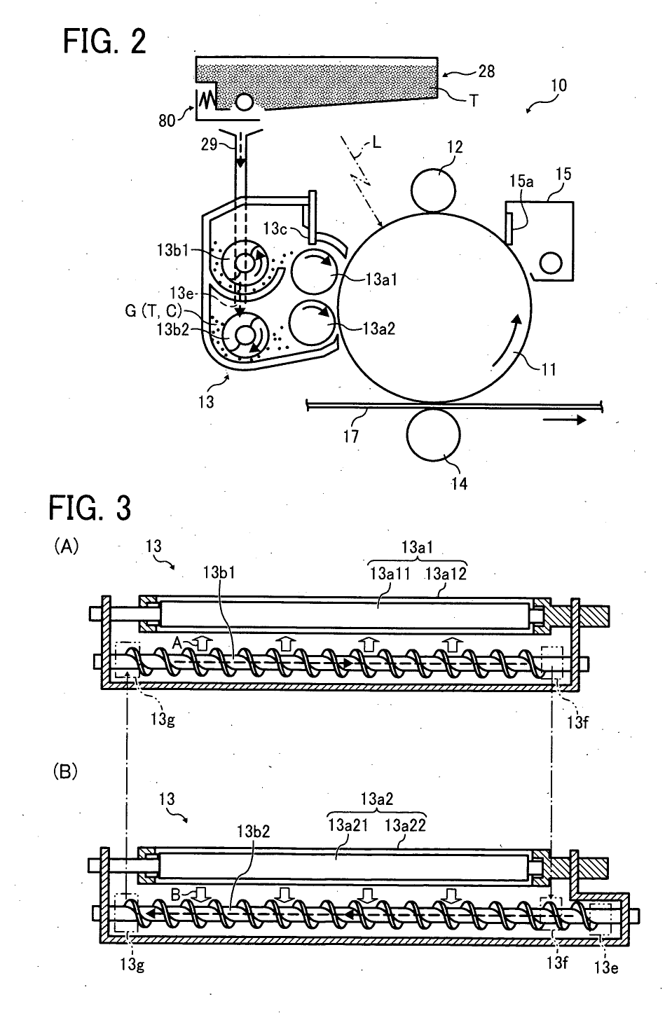

Additionally, reference number 16 represents a belt cleaning unit to clean a surfaces of the intermediate transfer belt 17, 18 represents a secondary-transfer bias roller to transfer the toner image from the intermediate transfer belt 17 onto the sheet P, and 20 represents a fixing device to fix the toner image on the sheet P. Additionally, toner containers 28 (shown in FIG. 2) respectively containing yellow, cyan, magenta, and black toners to be supplied to the respective development devices 13 are provided above the photoconductors 11 although not shown in FIG. 1.

Operations of the image forming apparatus 1 shown in FIG. 1 to form multicolor images are described below. It is to be noted that FIG. 2 is also referred to when image forming process performed on the respective photoconductor drums 11 are described.

In the document feeder 3, transport rollers, not shown, transport original documents D set on a document table, not shown, in a direction indicated by an arrow onto a contact glass 5 of the document reading unit 4. Then, the document reading unit 4 reads image data of the original document D set on the contact glass 5 optically.

More specifically, the document reading unit 4 scans the image in the original document D with light emitted from an illumination lamp, not shown. The light reflected by a surface of the original document D is imaged on a color sensor via mirrors and lenses, not shown. The color sensor reads the multicolor image data of the original document D for each decomposed colors of red, green, and blue (RGB) and convert the image data into electrical image signals. Further, the image signals are transmitted to an image processor, not shown, that performs image processing (e.g., color conversion, color calibration, and spatial frequency adjustment) according to the image signals, and thus image data of yellow, magenta, cyan, and black is obtained.

The yellow, magenta, cyan, and black single-color image data is then transmitted to the writing unit 2, and the writing unit 2 directs laser beams L (shown in FIG. 2) corresponding to the single-color image data to the respective photoconductor drums 11.

Meanwhile, the four photoconductor drums 11 rotate clockwise in FIG. 1. Initially, the surface of each photoconductor drum 11 is charged uniformly by the charging member 12 at a position facing the charging member 12 to a predetermined or given charge electrical potential, which is referred to as a charging process. When the surface of the photoconductor drums 11 reach positions to receive the laser beams L, respectively, the writing unit 2 directs the laser beams L according to the respective color image date, emitted from four light sources (not shown), to the respective photoconductor drums 11, which is referred to as an exposure process. The four laser beams L pass through different optical paths for yellow, magenta cyan, and black.

The laser beam L corresponding to the yellow component is directed to the photoconductor drum 11Y, which is the first from the left in FIG. 1 among the four photoconductor drums 11. A polygon mirror, not shown, that rotates at high velocity deflects the laser beam L for yellow in a direction of a rotation axis of the photoconductor drum 11Y (main scanning direction) so that the leaser beam L scans the surface of the photoconductor drum 11Y. Thus, an electrostatic latent image for yellow is formed on the photoconductor drum 11 charged by the charging member 12.

Similarly, the laser beam L corresponding to the magenta component is directed to the surface of the photoconductor drum 11M, which is the second from the left in FIG. 1. The laser beam L corresponding to the cyan component is directed to the surface of the photoconductor drum 11C, which is the third from the left in FIG. 1. The laser beam L corresponding to the black component is directed to the surface of the photoconductor drum 11BK that is the fourth from the left in FIG. 1. Thus, electrostatic latent images for magenta, cyan, and black are formed on the photoconductor drum 11M, 11C, and 11BK, respectively.

Then, each photoconductor drum 11 reaches a position facing the development device 13, and the development device 13 supplies toner of the corresponding color to the photoconductor drum 11. Thus, the latent images on the respective photoconductor drums 11 are developed into different single-color toner images in a development process.

Then, each photoconductor drum 11 reaches a position facing the intermediate transfer belt 17 where the primary transfer roller 14 is disposed in contact with an inner circumferential surface of the intermediate transfer belt 17. At these positions, the toner images formed on the respective photoconductor drums 11 are sequentially transferred and superimposed one on another on the intermediate transfer belt 17, forming a multicolor toner image thereon, in a primary transfer process. After the primary transfer process, the surface of each photoconductor drum 11 reaches a position facing the cleaning unit 15, where the cleaning unit 15 collects any toner remaining on the photoconductor drum 11 in a cleaning process. Additionally, the surface of each photoconductor drum 11 passes through a discharge device, not shown, and thus a sequence of image forming processes performed on each photoconductor drum 11 is completed.

Meanwhile, the intermediate transfer belt 17 carrying the multicolor toner image further rotates clockwise in FIG. 1 to a secondary transfer nip where the secondary-transfer bias roller 18 presses against the intermediate transfer belt 17, and then the multicolor toner image is transferred from the intermediate transfer belt 17 onto the sheet P in a secondary transfer process. After the secondary transfer process, the intermediate transfer belt 17 reaches a position facing the belt cleaning unit 16, where any toner remaining on the intermediate transfer belt 17 is collected by the belt cleaning unit 16. Thus, a sequence of image forming processes performed on the intermediate transfer belt 17 is completed.

Herein, sheets P are transported from one of the sheet cassettes 7 via the registration rollers 9, etc., to the secondary transfer nip formed between the intermediate transfer belt 17 and the secondary-transfer bias roller 18. More specifically, the feed roller 8 sends out the sheet P from the sheet cassette 7, and the sheet P is then guided by a sheet guide, not shown, to the registration rollers 9. The registration rollers 9 forward the sheet P to the secondary transfer nip, timed to coincide with the arrival of the multicolor toner image formed on the intermediate transfer belt 17.

Then, a transport belt, not shown, transports the sheet P to the fixing device 20, and the toner image is fixed on the sheet P in a nip where a fixing belt and a pressure roller, not shown, of the fixing device 20 press against each other. After the fixing process, discharge rollers, not shown, discharge the sheet P as an output image outside the image forming apparatus 1. Thus, a. sequence of image forming processes is completed.

Next, image forming units are described below with reference to FIG. 2.

FIG. 2 illustrates an image forming unit 10 and the toner container 28. It is to be noted that the four image forming units 10 and the four toner containers 28 have similar configurations, and thus the subscripts Y, C, M, and BK are omitted in the drawings for simplicity.

As shown in FIG. 2, each image forming unit 10 includes the photoconductor drum 11, the charging member 12, the development device 13, the cleaning unit 15, and the like. The photoconductor drum 11 in the present embodiment is a negatively-charged organic photoconductor having an external diameter of about 30 mm and is rotated counterclockwise in FIG. 2 by a driving unit, not shown.

The charging member 12 is an elastic charging roller and can be formed by covering a metal core with an elastic layer of moderate resistivity. For example, the elastic layer of moderate resistivity can be a foamed urethane layer including carbon black as electro-conductive particles, sulfur zing agent, foaming agent, and the like. The material of the elastic layer of moderate resistivity include, but not limited to, rubber such as urethane, ethylene-propylene-dyne (EPDM), acrylonitrile butadiene rubber (NBR), silicone rubber, and isoprene rubber to which electro-conductive material such as carbon black or metal oxide is added to adjust the resistivity. Alternatively, foamed rubber including these materials may be used. The cleaning unit 15 includes a cleaning blade 15a that slidingly contacts the surface of the photoconductor drum 11 and removes any toner adhering to the photoconductor drum 11 mechanically.

Referring to FIG. 2, the development device 13 includes first and second development rollers 13a1 and 13a2, and first and second development areas (development nips) where magnetic brushes formed on the first and second development rollers 13a1 and 13a2 contact the surface of the photoconductor drum 11 are formed in the portion where the first and second development rollers 13a1 and 13a2 face the photoconductor drum 11 in the development device 13. The development device 13 contains two-component developer (developer particles) G including toner (toner particles) T and carrier (carrier particles) C with which the development device 13 develops the latent image (forms toner image) formed on the photoconductor drum 11 into a toner image.

The configuration and operation of the development device 13 are described in further detail later.

Referring to FIG. 2, the toner container 28 contains toner T to be supplied to the development device 13. The toner container 28 includes a shutter 80, and a controller (not shown) of the image forming apparatus 1 shown in FIG. 1 causes a shutter driving unit (not shown) to open and close the shutter 80 according to toner concentration, which is the ratio of the toner T in the developer G, detected by a magnetic sensor (not shown) provided in the development device 13, thus supplying the toner T from the toner container 28 to the development device 13 as required.

It is to be noted that the data according to which the toner T is supplied is not limited to the toner concentration, and alternatively, the toner T may be supplied according to toner consumption. For example, toner consumption may be determined based on the image density calculated from the reflectance of the toner image formed on the photoconductor drums 11 or the intermediate transfer belt 17. Yet alternatively, the toner may be supplied according to a combination of such data. A supply tube 29 connects together the toner container 28 and the development device 13 to guide the toner T discharged from the tone container 28 so that the toner T can be reliably supplied to the development device 13 through a supply port 13e formed in the development device 13.

The weight-average particle diameter of toner particles T used in the present embodiment is within a range from about 5 μm to 10 μm, and percentage by number of toner particles whose weight-average particle diameter in total toner particles T is equals to or less than 5 μm is within a range of from 60 to 80. Thus, since the small particle toner is used, dot reproducibility in outputted images can be improved.

Next, the operation and configuration of the development device 13 in the image forming apparatus is described below.

With reference to FIGS. 2 through 5, the development device 13 includes the first and second development rollers 13a1 and 13a2, disposed close to the photoconductor drum 11, first and second transport screws 13b1 and 13b2 (screw augers), serving as transport members, and a doctor blade 13c.

The outer diameter of the respective development rollers 13a1 and 13a2 is set to 20 mm. The development rollers 13a1 and 13a2 respectively include cylindrical sleeves 13a12 and 13a22 that are formed of a nonmagnetic material such as aluminum, brass, stainless steel, or conductive resin and are rotated clockwise in FIG. 2 by a driving unit, not shown. The first development roller 13a1 includes the first sleeve 13a12 and a first magnet 13a11, serving as a magnetic field generator, provided inside the sleeve 13a12. The second development roller 13a2 includes the second sleeve 13a22 and a second magnet 13a21, serving as a magnetic field generator, provided inside the second sleeve 13a22.

The first development roller 13a1 is disposed at a position facing the doctor blade 13c. By contrast, the second development roller 13a2 is disposed at a position not facing the doctor blade 13c and is downstream from a position at which the first development roller 13a1 faces the photoconductor drum 2 in a direction in which the photoconductor drum 11 is rotated, indicated by arrow E shown in FIG. 2.

Referring to FIGS. 3 and 5, the first magnet 13a11, whose position is fixed relative to the first sleeve 13a12 of the first development roller 13a1, generates multiple magnetic poles, namely, a first main pole H1, an attraction pole H2, and a first transport pole H3 (shown in FIG. 5), around a circumferential surface of the first sleeve 13a12. The second magnet 13a21, whose position is fixed relative to the second sleeve 13a22 of the second development roller 13a2, generates multiple magnetic poles, namely, a receiving pole H4, a second main pole H5, and a second transport pole H6 (shown in FIG. 5), around a circumferential surface of the second sleeve 13a22. It is to be noted that reference characters S and N enclosed in brackets shown in FIG. 5 represent south pole and north pole, respectively, as the polarity of the magnetic poles H1 through H6.

While rotating in the direction, the first development roller 13a1 transports the developer G carried on its circumferential surface to a position facing the doctor blade 13c (hereinafter “doctor gap”), where the amount of the developer G is adjusted, and further transports it to a first development area facing the photoconductor drum 11. Then, the toner in the developer G adheres to the latent image formed on the photoconductor drum 11 due to the effect of the magnetic field generated in the first development area. Thus, a first development process is performed.

Subsequently, the first development roller 13a1 further transports the developer G carried on its circumferential surface to a position facing the second development roller 13a2. Then, the developer G carried on the first development roller 13a1 is received by the second development roller 13a2 and then is transported with the rotation of the second development roller 13a2. Subsequently, the second development roller 13a2 transports the developer G carried on its circumferential surface to a second development area facing the photoconductor drum 11. Then, the toner in the developer G adheres to the latent image formed on the photoconductor drum 11 due to the effect of the magnetic field generated in the second development area. Thus, a second development process is performed.

As described above, because the multiple development rollers 13a1 and 13a2 are positioned facing the photoconductor drum 11, the development area can be lengthened in the rotation direction (moving direction) of the photoconductor drum 11. Accordingly, when the rotation velocity (process liner speed) is increased, higher quality image can be formed.

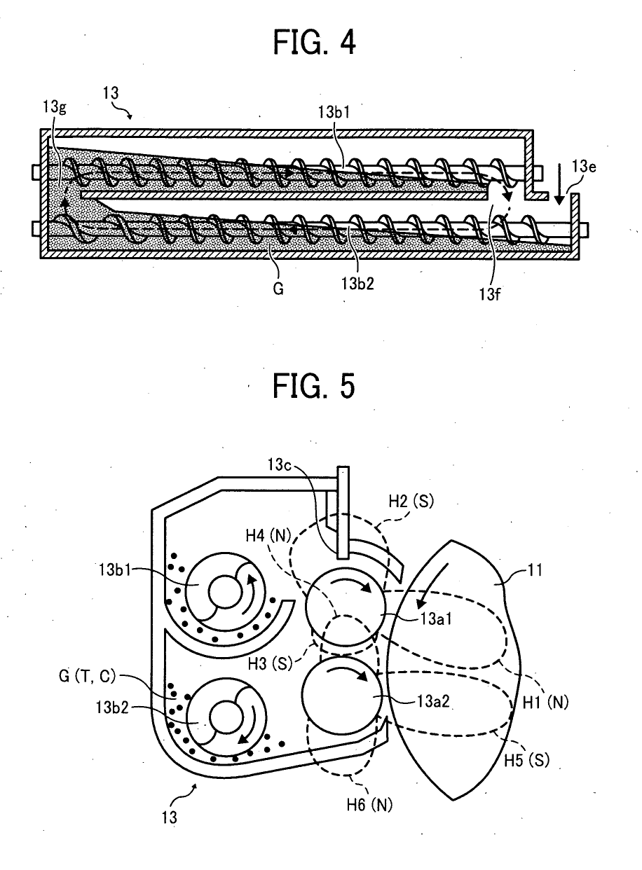

FIG. 4 illustrates a vertical cross section of the development device 13 in the longitudinal direction. FIG. 5 is an end-on axial view that illustrates distribution of the lines of magnetic force exerted by the magnetic poles H1 through H6 generated by the magnets 13a11 and 13a21 in a portion surrounding the sleeves 13a12 and 13a22 of the development rollers 13a1 and 13a2.

As shown in FIG. 5, in the first development roller 13a1, the first main pole H1 is disposed in the portion facing the photoconductor drum 11, the first transport pole H3 is disposed downstream from the first main pole H1 in a direction in which the first development roller 13a1 rotates and is disposed in the portion facing the second development roller 13a2, and the attraction pole (doctor blade facing pole) H3 extends between a portion facing the first transport chamber 31 and a portion facing the doctor blade 13c. In the second development roller 13a2, the second main pole H5 is disposed in the portion facing the photoconductor drum 11, the reception pole H4 is disposed upstream from the second main pole H5 in a direction in which the second development roller 13a2 rotates and is disposed in the portion facing the first development roller 13a1, and the second transport pole H6 to transport the developer to the portion facing the second transport chamber 32.

Initially, at a position where the magnetic force of the attraction pole H2 acts on the magnetic carrier particles in the developer G, the developer G contained in the first transport chamber 31 is carried on the first development roller 13a1. Then, at a predetermined or given position in the area where the magnetic force exerted by the attraction pole H2 acts on the developer G, the doctor blade 13c scrapes off any excess developer G from the circumferential surface of the first development roller 13a to adjust the amount of the developer G carried thereon, and the excess developer G is returned to the first transport chamber 31.

The developer particles G that have passed through the doctor gap between the doctor blade 13c and the circumferential surface of the first development roller 13a1 stand on end on the first development roller 13a due to the magnetic force exerted by the first main pole H1, forming a magnetic brush in the first development area and slidingly contact the surface of the photoconductor drum 11.

Thus, the toner particle T in the developer G carried on the first development rollers 13a1 adheres to the latent image on the photoconductor drum 11.

Then, the developer G that have passed through the vicinity of the first main pole H1 is transported to the portion facing the second development roller 13a2 by the first transport pole H3. At this position, the developer carried on the first development roller 13a1 is moved onto the second development roller 13a2 by the receiving pole H4.

Subsequently, the developer particles G carried on the second development roller 13a2 stand on end on the first development roller 13a due to the magnetic force exerted by the second main pole H5, forming a magnetic brush in the second development area and slidingly contact the surface of the photoconductor drum 11.

Thus, the toner T in the developer G carried on the second development roller 13a2 adheres to the latent image formed on the photoconductor drum 11. The developer G that has passed through the vicinity of the second main pole H5 is transported to the portion facing the second transport chamber 32 by the second transport pole H6, Then, because the magnetic pole is not formed in this portion, the developer G used in the development process leaves the second development roller 13a2.

Then, the developer G released from the second development roller 13a2 falls into the second transport chamber 32 and transported downstream by the second transport screw 13b2 therein.

The first transport screw 13b1 and the second transport screw 13b2 agitate and mix the developer G contained in the development device 13 while transporting the developer G horizontally in the longitudinal direction, that is, the axial direction, perpendicular to the surface of the paper on which FIG. 2 is drawn.

FIG. 3 schematically illustrates horizontal cross sections of the development device 13, and (A) and (B) respectively illustrate an upper portion (first transport chamber 31) and a lower portion (second transport chamber 32) of the development device 13 in a longitudinal direction of the development device 13.

The first transport screw 13b1 is disposed facing the first development roller 13a1 and supplies the developer G to the first development roller 13a1 as indicated by hollow arrows A and B shown in (A) of FIG. 3 at the attraction position corresponding to the attraction pole H2 shown in FIG. 5 while transporting the developer G to the right in FIG. 3 in the first transport chamber 31 as indicated by a broken arrow shown in (A) of FIG. 3.

The second transport screw 13b2 is disposed beneath the first transport screw 13b1 and faces the development roller 13a. The developer G that has been used in image development and has left the development roller 13a is collected in the second transport chamber 32 as indicated by hollow arrows shown in (B) of FIG. 3, separated from the second development roller 13a2 and is then transported by the second transport screw 13b2 to the left in the second transport chamber 32 as indicated by a broken arrow shown in (B) of FIG. 3. It is to be noted that, in the present embodiment, the second transport screw 13b2 is configured to rotate in the direction identical to the rotational direction of the development roller 13a, that is, clockwise in FIG. 2.

Similarly to the first and second development rollers 13a1 and 13a2 and the photoconductor drum 11, the first and second transport screws 13b1 and 13b2 are disposed so that their axes of rotation are substantially horizontal. Each of the first and second transport screws 13b1 and 13b2 are formed with a screw shaft and a bladed screw spiral having an external diameter of 16 mm or less and winding around the screw shaft.

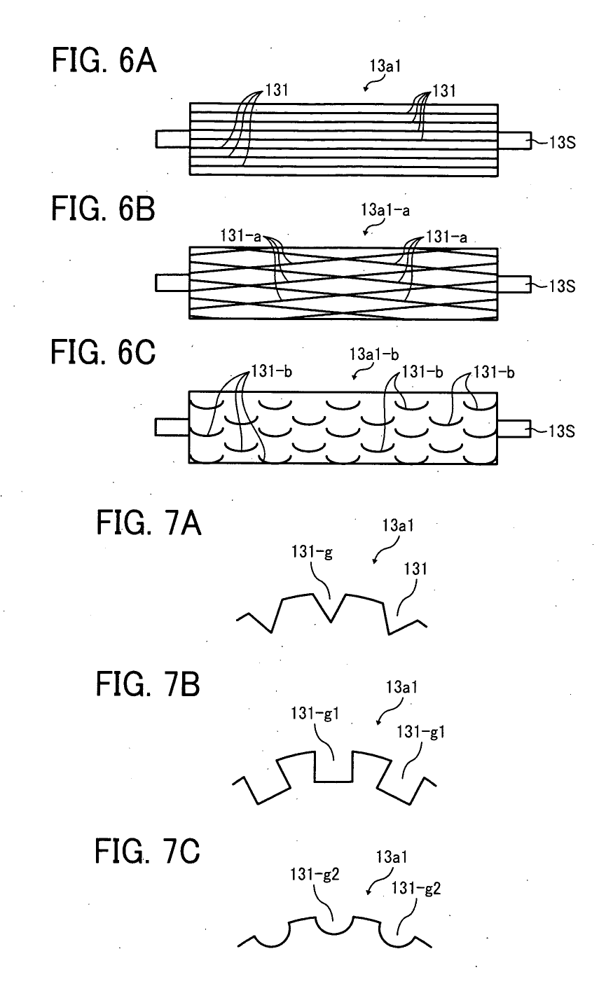

It is to be noted that an interior wall 13h of the development device 13 separates a first transport chamber or supply chamber 31 in which the first transport screw 13b1 is disposed from a second transport chamber or collection chamber 32 in which the second transport screw 13b2 is disposed. The first and second transport chambers 31 and 32 contain the developer. The interior wall 13h encloses the first transport screw 13b1 and is also referred to as a jaw-like portion of the first transport chamber 31. Further, a partition 13d (shown in FIG. 6) extending from a surface of the interior wall 13h divides an area in the second transport chamber 32.

Although the first transport chamber 31 and the second transport chamber 32 are separated, a downstream portion of the first transport chamber 31 communicates with an upstream portion of the second transport chamber 32 through a first communication port 13f, and a downstream portion of the second transport chamber 32 communicates with an upstream portion of the first transport chamber 31 through a second communication port 13g, serving as a communication port, in a direction in which the developer G is circulated in the development device 13 (hereinafter “developer circulation direction”).

Further, the developer G that is not supplied to the development roller 13a by the first transport screw 13b1 falls under gravity from the downstream portion of the first transport chamber 31 to the upstream portion of the second transport chamber 32 through the first communication port 13f as indicated by a downward broken arrow shown in FIG. 3. The developer G accumulates in the downstream portion of the second transport chamber 32, and the developer G thus piled up is sent from the downstream portion of the second transport chamber 32 to the upstream portion of the first transport chamber 31 through the second communication port 13g as indicated by an upward broken arrow shown in FIG. 3 in the developer circulation direction.

With this configuration, the first and second transport screws 13b1 and 13b2 forms a circulation path through which the developer G is circulated in the development device 13 is formed. That is, when the development device 13 is activated, the developer G contained therein flows in the developer circulation direction indicated by the broken arrows shown in FIGS. 3 and 4. Separating the supply chamber 31(first transport path) from which the developer is supplied to the first development roller 13a1 from the collection chamber 32 (second transport path) to which the developer G that has left the second development roller 13a2 is collected can reduce unevenness in the amount of toner forming the toner image (image density) on the photoconductor drum 11.

It is to be noted that the magnetic sensor (not shown) to detect the toner concentration in the developer circulated in the development device 13 is disposed in the collection chamber (second transport chamber) 32. Based on the toner concentration detected by the magnetic sensor, the fresh toner T is supplied from the toner container 28 to the development device 13 through the supply port 13e disposed adjacent to the first communication port 13f in the collection chamber 32.

Additionally, referring to FIGS. 3 and 4, the supply port 13e is formed in an upper portion in the upstream portion of the collection chamber 32, in which the second transport screw 13b2 is disposed, away from the development area, that is, disposed outside the area occupied by the second development roller 13a2 in the longitudinal direction. Disposing the supply port 13e close to the first communication port 13f can attain such effects that the used developer that has left the second development roller 13a2 can fall on the supplied toner whose specific gravity is smaller and the mixture is transported downstream in the collection chamber 32 for a relatively long time. Accordingly, the supplied toner can be better dispersed in the developer. It is to be noted that the position of the supply port 13e is not limited to inside the collection chamber 32 but can be in an upper portion in the upstream portion of the supply chamber 31, for example.

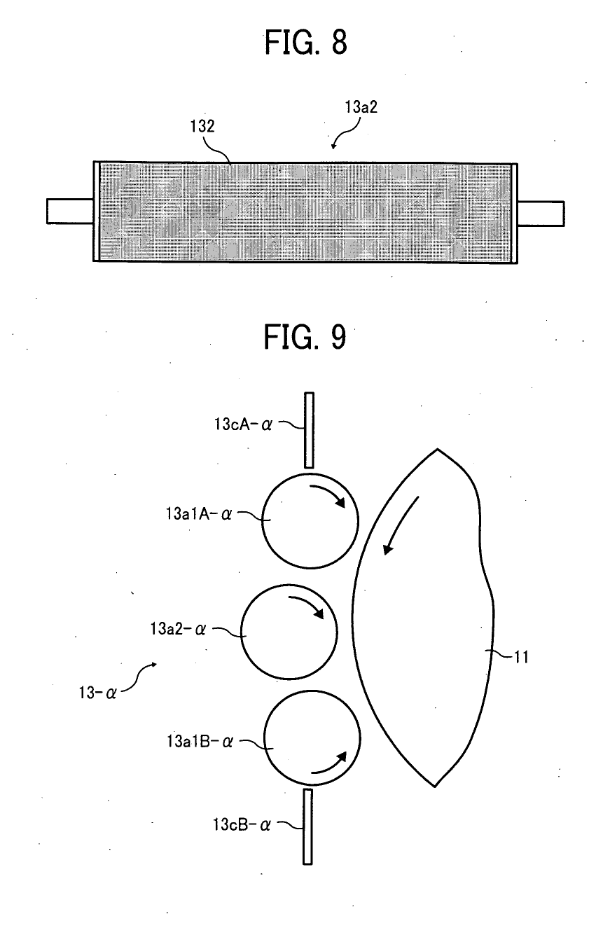

Next, specific features of the development device 13 according to the present embodiment are described below, with reference to FIGS. 2 through 8.

In the development device 13 according to the present embodiment, multiple grooves 131 are formed in the surface of the first sleeve 13a12 of the first development roller 13a1 disposed facing the doctor blade 13c serving as the developer regulator. Meanwhile, the surface of the second sleeve 13a22 of the second development roller 13a22 that does not face the doctor blade 13c is blasted by abrasive blasting such as sandblasting, and thus, a convex and concave irregular face (blasting area 132) is formed on the second development roller 13a2.

Herein, the sandblasting is a process used to abrade a surface of an object to form convex and concave irregularities by causing particles (blast material) whose particle diameter is several ten micrometers to impact against a predetermined area of the surface of the object. The blast material used for sandblasting is preferably selected according to the properties of the material of the surface of the second development roller, and examples of the blast material include Silica sand, river sand, cast-ion grit, cast-steel grit, cut wires, alumina grit, Silicon Carbide grit, slag grit, and glass beads.

More specifically, referring to FIG. 6A, in the first development roller 13a1, the multiple grooves 131 extending along an axial rotary shaft 13s of the development roller 13a1 are formed all along the circumferential surface of the first development roller 13a1, at predetermined intervals in a circumferential direction of the first development roller 13a1.

The multiple grooves 131 formed in the surface of the first development roller 13a1 (first sleeve 13a12) improve the transport ability (retaining force) of the developer G on the first development roller 13a1 (sleeve 13a12). Configurations of V-shaped grooves 131-g, square U-shaped grooves 131-g1, concave grooves 131-g2 illustrated in FIGS. 7A through 7C are also possible.

Herein, in the present embodiment, each of a groove 131-g is V-shaped as shown in FIG. 7A, and its depth is about 0.2 mm. In addition, the 50 grooves 131 whose pitch is 7.2° are grooved at the same interval on the surface of the first development roller 16a1 whose outer diameter is 20 mm.

Although the first development roller 13a1 thus grooved is less likely to retain the developer uniformly on the entire surface thereof, the toner adhesion is more likely to occur over time, thus making the image quality unstable compared with the second development roller 13a2, wherein the groove 131 of the first development roller 13a1 is less likely wear down over time even facing the doctor blade 13c, and the degree of the degradation in the transport ability (retaining force) of the developer cab be relatively smaller.

Herein, the grooves 131 are not limited to the configuration in which the multiple linear grooves 131 are formed along the rotation shaft 13s of the first development roller 13a1, shown in FIG. 6A. For example, as shown in FIG. 6B, multiple grooves 131-a oblique relative to the rotary shaft 13s of the first development roller 13a1-a can be used. In this configuration, the grooves 131-a form a pattern of intersecting slanted lines. Further, as shown in FIG. 6C, multiply scaly grooves 131-b may be formed on entire surface of the development roller 13a1-b. More specifically, centers of the respective grooves 131-b are aligned with each other in the direction of the rotary shaft 13s, and both side ends of each groove 131-b is curved and oblique to the direction of the rotary shaft 13s.

Conversely, the blasting area 132 is formed at least in an entire image area on the surface of the second development roller 13a2. That is, the convex and concave irregular face (blasting area 132) is formed on the second development roller 13a2. More specifically, in the second development roller 13a2, the blasting area 132 in the surface of the sleeve 13a22 is roughened by sandblasting so that an arithmetical mean roughness (Ra) of the surface of the sleeve 13a22 is set to be about 6 μm.

Although the concavities and convexities on the surface of the second development roller 13a2 thus sandblasted has poorer resistance to abrasion over time than the grooved first development roller 13a1, and accordingly the degree of deterioration in the transport ability (retaining force) of the developer is lower, compared with the first development roller 13a1 the developer can be uniformly kept on the surface of the second development roller 13b2, which prevents adhesion of the toner and stabilizes image quality.

As described above, because the grooves 131 are formed on the first development roller 13a (sleeve 13a12) facing the doctor blade 13c and the blasting area 132 is formed in the surface of the second development roller 13a2 (sleeve 13a22), the insufficiencies of both development rollers 13a1 and 13a2 offset each other, and their advantages can be effectively utilized. That is, although the first development roller 13a1 faces the doctor blade 13c and is subjected to heavy pressure in the portion facing the doctor gap, the grooves 131 formed in the surface thereof can have resistance to abrasion, and the transport ability (retaining force) of the developer can be maintained over time. As a result, decreases in the image density due to the reduction in the amount of the developer to be transported to the first development area by the first development roller 13a1 can be prevented.

Herein, because the surface of the first development roller 13a1 is less likely to keep the developer uniformly, the image quality of the toner image formed on the photoconductor drum 1 in the first development area is unstable. However, in order to make up for insufficiency, because the second development roller 13a2 whose entire surface retains the developer G uniformly in the second development area, the toner image whose image quality is stable can be formed on the photoconductor drum 11. It is to be noted that, since the second development roller 13c does not face the doctor blade 13c, heavy pressure is less likely to be exerted on the surface of the second development roller 13a2, and therefore, the concavities and the convexities on the surface thereof have resistance to abrasion, and the transport ability (retaining force) of the developer can be maintained.

As described above, the development device 13 of the first embodiment can maintain reliable transport ability of the developer and image quality over time.

In addition, in the first embodiment, it is preferable that the surface of the development rollers 13a1 and 13a2 are formed of electrically conductive material. For example, when coating films covers the surfaces of the sleeves 13a12 and 13a22 in the development rollers 13a1 and 13a2, the coating films are preferably electrically conductive.

Herein, it is assumed that the surfaces of the development rollers 13a1 and 13a2 are formed of insulator material, which is similar to a state in which toner is firmly fixed to the entire surfaces of the development rollers 13a1 and 13a2. Then, when an electric charge is applied to its surface formed of the insulator material, the electric charge does not move and then accumulates on the surfaces of the development rollers 13a1 and 13a2. As a result, static electric fields between the respective development rollers 13a and 13a2 and the photoreceptor drums 11 are changed, which causes the scattering on the background of the image formed on the photoreceptor drum 11 and the reduction of the toner concentration of the developer.

By contrast, because the surfaces of the development rollers 13a1 and 13a2 are made of the electronically conductive material, when the electric change is applied to the surface thereof, the charge is, immediately moved to the photoconductor drum 11 and does not accumulate on the surface of the development roller 13a1 and 13a2. Accordingly, the scattering on the background of the image formed on the photoconductor drum 11 and the reduction of the toner concentration in the developer G can be prevented.

Further, in the present embodiment, it is preferable that both surfaces of the development rollers 13a1 and 13a2 are formed of nonmagnetic material. The two-component developer G used in the development device 13 is constituted essentially of magnetic carrier particles C and nonmagnetic toner T. Therefore, in a case in which the surfaces of the development rollers 13a1 and 13a2 are formed of magnetic material, the carrier C is more likely to adhere to an improper portion in which the carrier C should not be borne on the surfaces of the development rollers 13a1 and 13a2, and the circulation of the developer G on the development rollers 13a1 and 13a2 (replacement from the used toner and new toner) become inactivated, which causes the developer to be carried over on the surfaces of the development rollers 13a1 and 13a2 (hereinafter “carrying over of developer”) even in the portion where the developer must leave the development roller 13a1 or 13a2. In the carried-over developer, the surface of carrier C does not carry enough of the toner T, thereby inviting deterioration of and fluctuation in the image density of the toner image formed on the photoreceptor drum 11.

By contrast, in the configuration in which the surfaces of the development rollers 13a1 and 13a2 are formed of nonmagnetic material, the carrying over of developer can be alleviated. Therefore, deterioration of and fluctuation in the image density in the image formed on the photoreceptor drum 11 can be prevented.

In addition, in the present embodiment, it is preferable that the sleeve 13a12 in the development roller 13a1 and the sleeve 13a22 in the development roller 13a1 are formed of aluminum. When the sleeves 13a12 and 13a22 are formed of aluminum, the surfaces of the development rollers 13a1 and 13a2c can be formed of electronically conductive material and the nonmagnetic. Further, the material cost for the development rollers 13a1 and 13a2c can become relatively inexpensive, and engraving the groove 131 and the blasting the blasting area 132 can be facilitated.

Herein, when the sleeves 13a12 and 13a22 are formed of aluminum, mechanical strength becomes degraded compared with sleeves formed of, for example, stainless steel, mechanical strength. However, because the abrasion-resistant grooves 131 are formed in the first development roller 13a1 that faces the doctor blade 13c and is subjected to strong pressure from the doctor blade 13c, and the second development roller 13a2 on which the blasting area 132 that resists abrasion poorly are positioned not to face the doctor blade 13c, even when the sleeves 13a12 and 13a22 are formed of aluminum, deformation of the sleeves 13a12 and 13a22 can be prevented.

As described above, in the present embodiment, because the grooves 131 are grooved on the surface of the first development roller 13a1 facing the doctor blade 13c (developer regulator), and the blasting is conducted on the surface of the second development roller 13a2 that does not face the doctor blade 13c, good transport ability of the developer G on the development rollers 13a1 and 13a2 can be kept over time, and the output image can be stably formed over time.

### Second Embodiment

Next, a development device 13-α according to a second embodiment is described below, with reference to FIG. 9.

FIG. 9 illustrates a main portion of the development device 13-α. Although illustration is omitted, similarly to the first embodiment, the development device 13-α according to the present embodiment includes the transport screws and the doctor blade serving as the developer regulator, in addition to the development rollers.

Differently from the development device 13 including two development rollers 13a1 and 13a2 and one doctor blade 13c according to the first embodiment, the development device 13-α according to the second embodiment includes three development rollers (first, second, and third development rollers 13a1A-α, 13a2-α, and 13a1B-α) and two doctor blades (first and second doctor blades 13cA-α and 13cB-α).

In the development device 13-αshown in FIG. 9, the first doctor blade 13cA-α is disposed at a position facing the first development roller 13a1A-α and the second doctor blade 13cB-α is disposed at a position facing the third development roller 13a1B-α that rotates in a counterclockwise direction. Also in the development device 13-α including the two doctor blades 13cA-α and 13cB-α, the grooves 131 are formed in the development rollers 13a1A-αand 13a1B-α positioned facing the doctor blades 13cA-α and 13cB-α, and the surface of the other development roller 13a2-α is abraded by abrasive blasting such as sandblasting. In this configuration, by forming the grooves 131 in the surfaces of the development rollers 13a1A-α and 13a1B-α that receive pressure from the doctor blades 13cA-α and 13cB-α and performing blasting on the surface of the second development roller 13a2-α that is less likely to be influenced by the doctor blades, the insufficiency of the development rollers 13a1A-α, 13a1B-α, and 13a2-α are offset respectively, and the advantages of them can be effectively utilized.

Herein, although the development rollers 13a1A-α and 13a1B-α face the doctor blades 13cA-α and 13cB-α and are subjected to heavy pressure in the portion facing the doctor gap, the grooves 131 formed in the surface thereof has resistance to abrasion, and the transport ability (retaining force) of the developer can be maintained over time. As a result, decreases in the image density due to the reduction in the amount of the developer to be transported to the first and third development areas by the development rollers 13a1A-α and 13a1B-α can be prevented.

It is to be noted that, since the second development roller 13a2-α does not face the doctor blades 13cA-α and 13cB-α, heavy pressure is less likely to be exerted on the surface of the development roller 13a2-α, and therefore, the concavities and the convexities on the surface thereof have resistance to abrasion. Thus, the transport ability (retaining force) of the developer can be maintained.

As described above, the development device 13-α of the second embodiment can maintain the ability of transporting the developer reliably over time and the image quality on the toner image over time.

### Third Embodiment

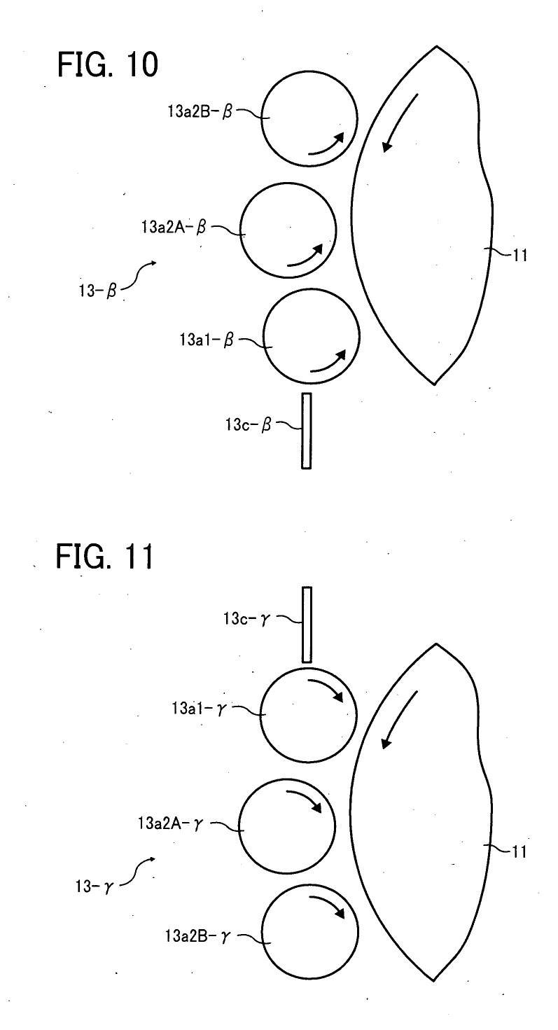

Next, a development device 13-β according to a third embodiment is described below with reference to FIG. 10.

Differently from the development device 13 according to the first embodiment that includes two development rollers 13a1 and 13a2 and one doctor blade 13c, the development device 13-β according to the third embodiment includes three development rollers (first, second, and third development rollers 13a1-β, 13a2A-β, and 13a2B-β). Further, differently from the first embodiment, rotation direction of the development rollers 13a1-β, 13a2A-β, and 13a2B-β is opposite to the direction in which the photoconductor drum 11 is rotated in the area facing the photoconductor drum 11, in the development device 13, and a doctor blade 13c-β is positioned downstream side in a direction in which the photoconductor drum 11 rotates.

In the development device 13-β shown in FIG. 10, the first development roller 13a1-β is provided extreme downstream among the three development rollers in the direction in which the photoconductor drum 11 is rotated and faces the doctor blade 13c-β.

Referring to FIG. 10, in the development device 13-β according to the third embodiment in which the three development roller 13a1-β, 13a2A-β, and 13a2B-β are rotated in the opposite direction to the direction in which the photoconductor drum 11 is rotated at the position between the development rollers 13a1-β, 13a2A-β, and 13a2B-β and the photoconductor drums 11, the grooves 131 is formed on the first development roller 13a1-β provided at the position facing a doctor blades 13c-β, and the surfaces of the other development rollers 13a2A-β and 13a2B-β are abraded by abrasive blasting such as sandblasting.

Also in this configuration, by forming the grooves 131 in the surface of the third development roller 13a1-β that receives pressure from the doctor blades 13c-β, and conducting blasting on the surfaces of the development rollers 13a2A-β and 13a2B-β that are less likely to be influenced by the doctor blade, effects similar to those described above can be achieved.

### Fourth Embodiment

Next, a development device 13-γ according to a fourth embodiment is described below, with reference to FIG. 11.

FIG. 11 illustrates a main portion of the development device 13-γ.

Differently from the development device 13 according to the above-described first embodiment that includes two development rollers 13a1 and 13a2, the development device 13-γ according to the fourth embodiment includes three development rollers similarly to the above-described second and third embodiments.

In the development device 13-γ shown in FIG. 11, three development rollers, namely, first, second, and third development rollers 13a1-γ, 13a2A-γ and 13a2B-γ, are disposed, in that order, in a direction in which the photoconductor 11 is rotated at a position facing the photoconductor drum 11. The configuration and the rotational direction of the first development roller 13a1-γ according to the fourth embodiment are similar to the first development roller 13a1-γ according to the first embodiment. The configuration and the rotation direction of the second and third development rollers 13a2A-γ and 13a2B-γ according to the fourth embodiment are similar to the second roller 13a2 according to the first embodiment.

The three development rollers 13a1-γ, 13a2A-γ, and 13a2B-γ, located at positions facing the photoconductor drum 11, rotate in a forward direction in which the photoconductor drum 11 is rotated (moving direction). That is, the photoconductor drum 11 rotates in a counterclockwise direction in FIG. 11 and all of the three development rollers 13a1-γ, 13a2A-γ, and 13a2B-γ rotate clockwise direction in FIG. 11. In addition, the first development roller 13a1-γ, which is provided extreme upstream among the development rollers 13a1-γ, 13a2A-γ, and 13a2B-γ in the direction in which the photoconductor drum 11 is rotated, is located in a position facing the doctor blade 13c.

In the development process, initially, the developer G is pumped up from the first transport chamber 31 (see FIG. 2) in the development device 13-γ to the first development roller 13a1-γ, and then, the amount of the developer G carried on the surface of the first development roller 13a1-γ is regulated at the position facing the doctor blade 13c-γ. Subsequently, the developer G carried on the first development roller 13a1-γ has been used in the first development in the first development area wherein the first development roller 13a1-γ faces the photoconductor drum 11 (first (upstream) development area), and is further sent to the second development roller 13a2A-γ. Then, the developer G carried on the second development roller 13a2A-γ has been used in the second development process in the second (midstream) development area where the second development roller 13a2A-γ faces the photoconductor drum 11, and is further sent to the third development roller 13a2B-γ. Subsequently, the developer G carried on the third development roller 13a2B-γ has been used in third development in “a third (downstream) development area” where the third development roller 13a2B-γ faces the photoconductor drum 11, and is further sent from the third development roller 13a2B-γ to the space (the second transport chamber 32) in the development device 13-γ.

Herein, because the grooves 131 are formed on the first development roller 13a1-γ facing the doctor blade 13c-γ and the blasting area 132 is formed in the surface of the development rollers 13a2A-γ and 13a2B-γ, the insufficiency of the development rollers 13a1-γ, 13a2A-γ and 13a2B-γ are offset respectively, and the advantages of them can be most effectively utilized in the development device including three development rollers.

Therefore, the development device 13-γ of the fourth embodiment can maintain the ability of transporting the developer reliably and higher image quality over time.

It is to be noted, because the development roller 13a1-γ having the grooved surface is less likely to bear the developer uniformly thereon, the quality of the toner image formed on the photoconductor drum 11 after the first development process in the development area facing the development roller 13a1-γ is unstable.

In view of the foregoing, in the development device 13-γ according to the present embodiment, in order to make up for insufficiency, the second development roller 13a2A-γ and third development roller 13a2B-γ whose entire surfaces retain the developer G uniformly can stabilize the toner image in the second development area and the third development area.

Therefore, the development device 13-γ according to the present embodiment can produce images of higher quality than those produced by the development device 13-α shown in FIG. 9 in which the third development roller 13a1B-α makes the toner image rather unstable again in the third developing area although the unstable toner image formed in the first (upstream) development area by the first development roller 13a1A-α can be complemented by the toner supplied by the second development roller 13a2-α in the second (midstream) development area.

Similarly, the toner images produced by the development device 13-γ according to the present embodiment can have higher quality than those produced by the development device 13-β shown in FIG. 10 according to the third embodiment in which the first development roller 13a1-β positioned extreme downstream in the rotational direction of the photoconductor drum 11 makes the toner image formed on the photoconductor drum 11 rather unstable although the stable toner image can be formed on the photoconductor drum 11 in the first development process by the third development roller 13a2B-β in the upstream development area and the toner image is further complemented in the second development process by the second development roller 13a2B-β in the midstream development area.

In addition, in the configuration in which the development rollers rotate forward to the direction in which the photoconductor drum is rotated in the area facing the photoconductor drum, the occurrence of image failure in which toner is partly absent in leading portions in halftone output images can be prevented, and horizontal and vertical ratio of lines in output images can be better, as compared with the configuration in which the development rollers rotate in the opposite direction to the direction in which the photoconductor drum is rotated in the area facing the photoconductor drum.

As described above, when the multiple development rollers are provided in the development device, it is preferable that all of the development rollers rotate forward to the direction in which the photoconductor drum 11 is rotated in the area facing the photoconductor drum 11 in the development device 13-γ shown in FIG. 11.

As described above, in the fourth embodiment, because the grooves 131 are formed in the surface of the development rollers 13a1-γ facing the doctor blade 13c-γ, and blasting is conducted on the surfaces of the development rollers 13a2A-γ and 13a2B-γ that do not face the doctor blade 13c-γ, good transport ability of the developer on the development rollers 13a1-γ, 13a2A-γ, and 13a2B-γ can be kept over time and good output image can be stably formed over time.

It is to be noted that, although the three development rollers 13a1-γ, 13a2A-γ, and 13a2B-γ are provided in the development device 13-γ according to the present embodiment, features of this specification are applicable to development devices that include four or more development rollers. Then, in this case, as similar effect as that of the fourth embodiment can be attained as well.

Furthermore, in the above-described embodiments, although development devices 13 and 13-γ include the transport screws to transport the developer in a longitudinal direction, features of this specification are naturally applicable to development devices that that includes a transport paddle to transport the developer in a short direction. In this configuration, the similar effect can be attained

It is to be noted that, although only fresh toner T is supplied from the toner container 28 to the development device 13 in the description above, alternatively, premixed fresh developer including toner T and carrier particles C may be supplied from a developer container to the development device 13. In this configuration, the development device 13 may further include a member to discharge excessive developer or used developer from the development device 13. In such a configuration, similar effects can be also attained.

In addition, although the independent development devices 13 are removably installable to the image forming apparatus 1 in the above-described embodiments, alternatively, one or more of the components of the image forming unit 10 (e.g., the photoconductor drum 11, the charging member 12, the development device 13, and the cleaning unit 15) may be united as a single unit (i.e., process cartridge) removably installable to the image forming apparatus 1.

Additionally, the number of the developer transport members (e.g., transport screws) are not limited to two but can be equal to or greater than three as long as at least two of them are disposed facing the development roller. In addition, the number of magnetic poles (e.g., H1 through H6) formed around the development rollers is not limited to six. In configurations in which the number of magnetic poles is less than or greater than six, effects similar to those obtained in the above-described embodiments can be attained by providing the partition 13d between the development roller 13a and the second transport screw 13b2 in the second transport chamber (collection chamber) 32.

Numerous additional modifications and variations are possible in light of the above teachings. It is therefore to be understood that, within the scope of the appended claims, the disclosure of this patent specification may be practiced otherwise than as specifically described herein.

What is claimed is:

1. A development device to develop a latent image on an image carrier with developer, the development device comprising:
a first rotatable development roller to bear the developer and provided facing the image carrier, comprising an axial rotary shaft and multiple grooves formed in a surface of the first development roller; and
a developer regulator, provided at a position facing the first development roller, to restrict the amount of developer borne on the first development roller; and
a second rotatable development roller to bear the developer and provided facing the image carrier and not facing the developer regulator, comprising an axial rotary shaft, the second development roller having a convex and concave irregular surface.

2. The development device according to claim 1, wherein the multiple grooves formed in the surface of the first development roller extend in a direction parallel to the axial rotary shaft of the development roller.

3. The development device according to claim 1, wherein the multiple grooves formed in the surface of the first development roller extend generally in an axial direction of the first development roller oblique to the axis of the development roller.

4. The development device according to claim 1, wherein the multiple grooves formed in the surface of the first development roller comprises multiple grooves in parallel to an axial direction of the first development roller and multiple grooves oblique to the axis of the development roller.

5. The development device according to claim 1, wherein the first development roller and the second development roller rotate in a forward direction in which the image carrier moves in respective, ranges where the first development roller and the second development roller face the image carrier.

6. The development device according to claim 1, wherein the surface of the first development roller and the surface of the second development roller comprise an electrically conductive material.

7. The development device according to claim 1, wherein the surface of the first development roller and the surface of the second development roller comprise a non-magnetic material.

8. The development device according to claim 1, wherein the first development roller and second development roller comprise aluminum sleeves.

9. The development device according to claim 1, housed in common case with a image carrier, forming a process cartridge.

10. An image forming apparatus, comprising
an image carrier to bear a latent image; and
a development device to develop the latent image on the image carrier with developer,
the development device comprising:
a first rotatable development roller to bear the developer and provided facing the image carrier, comprising an axial rotary shaft and multiple grooves formed in a surface of the first development roller; and
a developer regulator, provided at a position facing the first development roller, to restrict the amount of developer borne on the first development roller; and
a second rotatable development roller to bear the developer and provided facing the image carrier and not facing the developer regulator, comprising an axial rotary shaft, the second development roller having a convex and concave irregular surface.

11. The image forming apparatus according to claim 10, wherein the multiple grooves formed in the surface of the first development roller extend in a direction parallel to the axial rotary shaft of the development roller.

12. The image forming apparatus according to claim 10, wherein the multiple grooves formed in the surface of the first development roller extend generally in an axial direction of the first development roller oblique to the axis of the development roller.

13. A method for manufacturing a development device, comprising:
forming a first rotatable development roller to bear the developer and provided facing the image carrier, comprising an axial rotary shaft
forming multiple grooves formed in a surface of the first development roller arranged at intervals in a circumferential direction of the first development roller;
providing a developer regulator, at a position facing the first development roller, to restrict the amount of developer borne on the first development roller;
forming a second rotatable development roller to bear the developer and provided facing the image carrier and not facing the developer regulator, comprising an axial rotary shaft; and
abrading a surface of the second development roller to make convex and concave irregularities.

14. The method for manufacturing the development device according to claim 13, further comprising:
forming the multiple grooves in the surface of the first development roller in a direction parallel to the axial rotary shaft of the development roller.

15. The method for manufacturing the development device according to claim 13, further comprising:
forming the multiple grooves in the surface of the first development roller in generally an axial direction of the first development roller oblique to the axis of the development roller.

16. The method for manufacturing the development device according to claim 13, wherein the first development roller and the second development roller rotate in a forward direction in which the image carrier moves in respective ranges where the first development roller and the second development roller face the image carrier.

17. The method for manufacturing the development device according to claim 13, wherein the surface of the first development roller and the surface of the second development roller comprise an electrically conductive material.

18. The method for manufacturing the development device according to claim 13, wherein the surface of the first development roller and the surface of the second development roller comprises a non-magnetic material.

19. The method for manufacturing the development device according to claim 13, wherein the first development roller and second development roller comprise aluminum sleeves.

20. The method for manufacturing the development device according to claim 13, wherein the convex-concave irregularly uneven surface of the second development roller is formed by sandblasting.
